(19) United States
(12) Patent Application Publication
(10) Pub. No.: US 2024/0080193 A1
(43) Pub. Date: Mar. 7, 2024

(54) COUNTER INTEGRITY TREE

(71) Applicant: Arm Limited, Cambridge (GB)

(72) Inventors: Andreas Lars Sandberg, Cambridge (GB); Roberto Avanzi, Munich (DE); Alexander Klimov, Hadera (IL)

(73) Assignee: Arm Limited, Cambridge (GB)

(21) Appl. No.: 18/446,530

(22) Filed: Aug. 9, 2023

(30) Foreign Application Priority Data
Sep. 1, 2022 (GB) 2212713.8

(51) Int. Cl. H04L 9/32

(52) U.S. Cl. CPC H04L 9/32

(57) ABSTRACT

An apparatus comprises counter integrity tree circuitry to maintain a counter integrity tree having a plurality of nodes. The counter integrity tree circuitry is configured to store, in a first node of the counter integrity tree, an encrypted representation of two or more non-repeating counters and in a second, parent, node, an indication of a function value equal to a non-repeating function of the two or more non-repeating counters of the first node. The apparatus comprises integrity checking circuitry configured to check the integrity of the first node using the function value retrieved from the second node.

The present technique relates to the field of data processing.

Some data processing systems may need to store a large number of counters. While counters stored in trusted memory may be secured against attacks, trusted memory storage may be limited and so it may be required to store counters in a non-trusted memory such as external, or off-chip, memory. An attacker may be able to read data from the external memory or intercept the data as it is passed to the external memory, and/or tamper with data values stored in the external memory in an attempt to cause incorrect behaviour when such externally stored data is subsequently brought back into the processing system. It is desirable to check the integrity of the counters stored in non-trusted memory to identify when a counter has been modified since it was stored to memory. It is also desirable for the storage requirements of the counters to be reduced.

At least some examples provide an apparatus comprising:
counter integrity tree circuitry configured to maintain a counter integrity tree comprising a plurality of nodes;
wherein the counter integrity tree circuitry is configured to store:
   in a first node of the counter integrity tree, an encrypted representation of two or more non-repeating counters; and
   in a second node of the counter integrity tree, which is a parent node of the first node, an indication of a function value equal to a non-repeating function of the two or more non-repeating counters of the first node; and
integrity checking circuitry configured to check the integrity of the first node using the function value retrieved from the second node.

At least some examples provide a method of operating a data processing apparatus to maintain integrity of non-repeating counters, comprising:
maintaining a counter integrity tree comprising a plurality of nodes;
storing, in a first node of the counter integrity tree, an encrypted representation of two or more non-repeating counters;
storing, in a second node of the counter integrity tree, which is a parent node of the first node, an indication of a function value equal to a non-repeating function of the two or more non-repeating counters of the first node; and
checking the integrity of the first node using the function value retrieved from the second node.

At least some examples provide a computer program for controlling a host data processing apparatus to provide an instruction execution environment, comprising:
counter integrity tree program logic to maintain a counter integrity tree comprising a plurality of nodes;
wherein the counter integrity tree program logic is arranged to store:
   in a first node of the counter integrity tree, an encrypted representation of two or more non-repeating counters; and
   in a second node of the counter integrity tree, which is a parent node of the first node, an indication of a function value equal to a non-repeating function of the two or more non-repeating counters of the first node; and
integrity checking program logic to check the integrity of the first node using the function value retrieved from the second node.

The storage medium may be a non-transitory medium.

Further aspects, features and advantages of the present technique will be apparent from the following description of examples, which is to be read in conjunction with the accompanying drawings, in which:

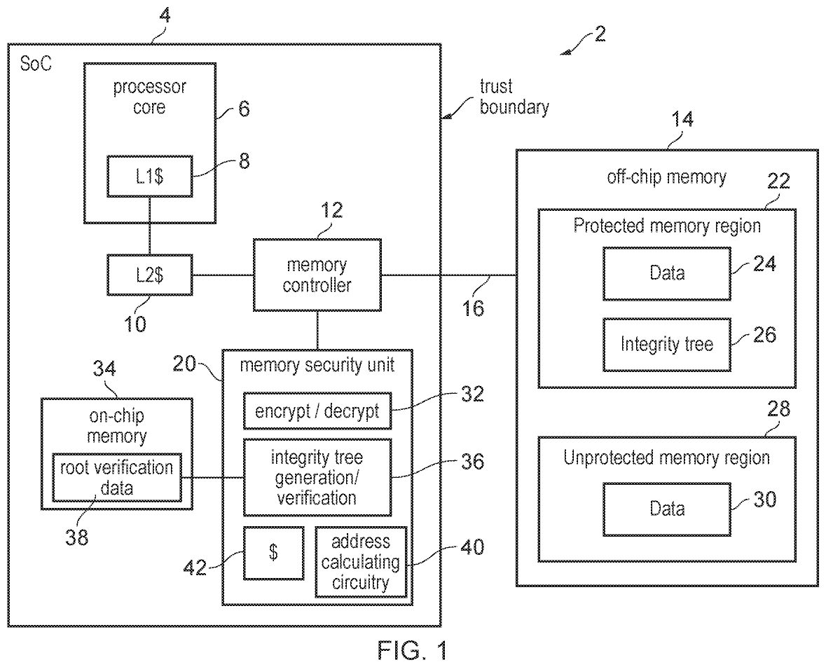

FIG. 1 schematically illustrates an example of a data processing system comprising on-chip and off-chip memory.

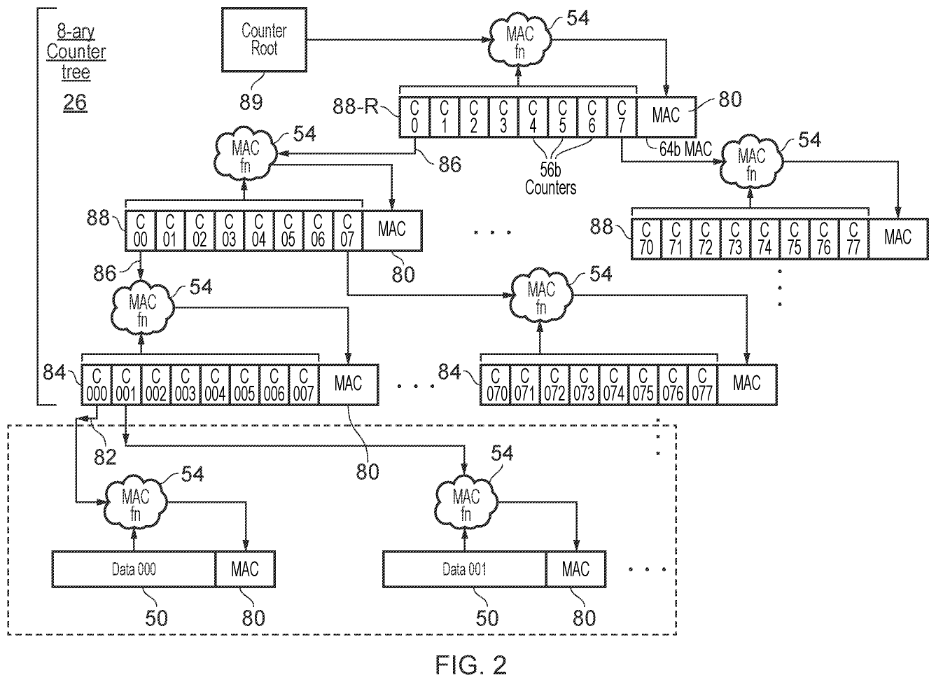

FIG. 2 schematically illustrates an example integrity tree.

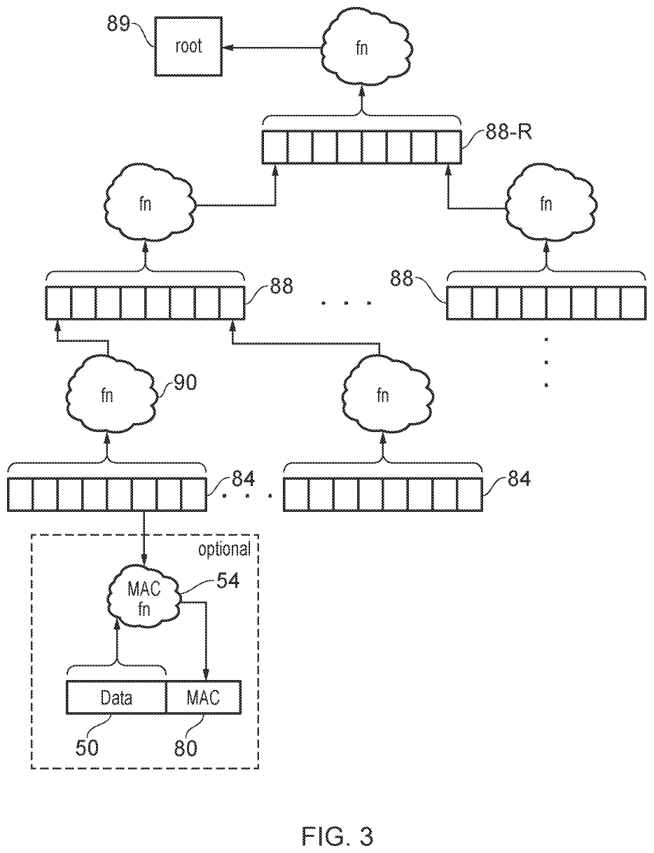

FIG. 3 schematically illustrates an integrity tree in which a parent node stores a monotonic function of monotonic counters stored in a child node.

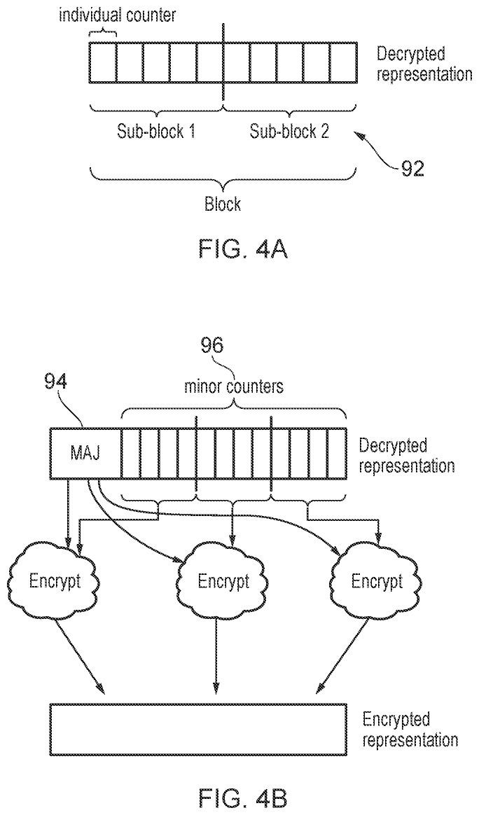

FIG. 4A schematically illustrates a node storing monotonic counters.

FIG. 4B schematically illustrates an encryption process for a node storing split counters.

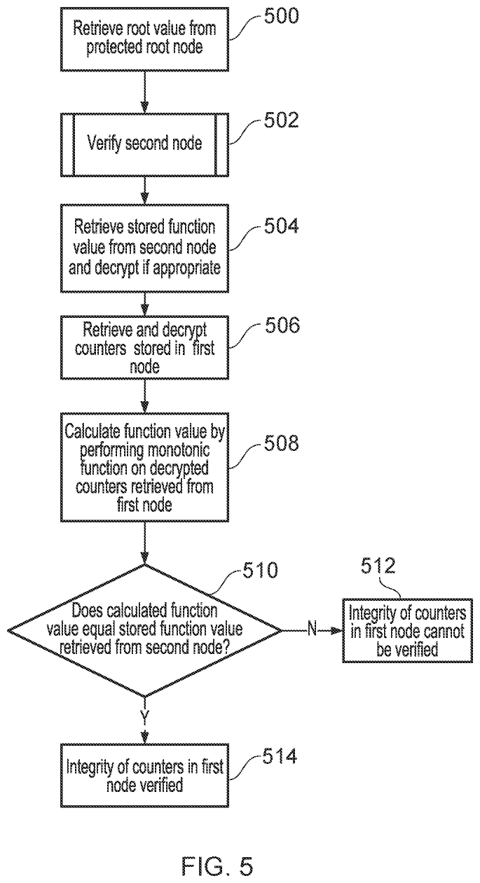

FIG. 5 is a flow diagram illustrating a method of using an integrity tree to verify the integrity of counters.

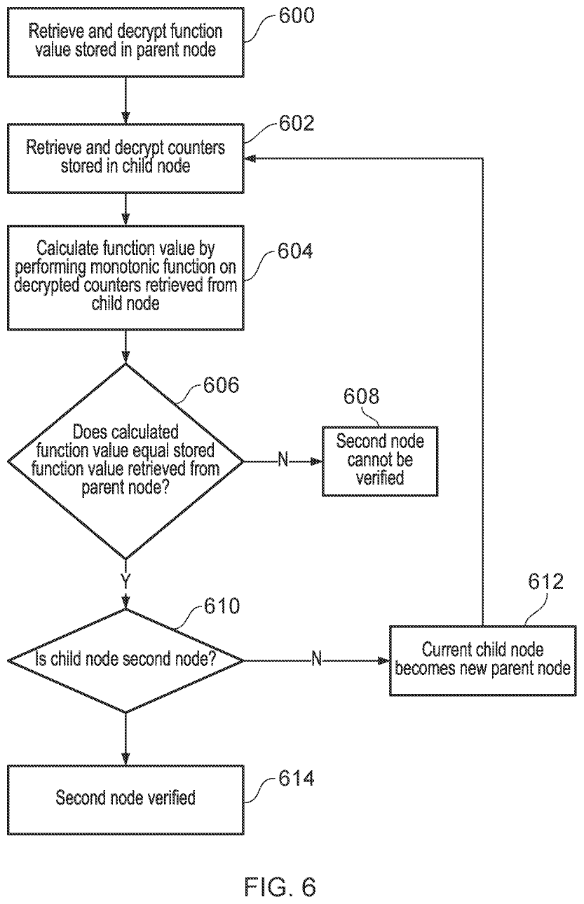

FIG. 6 is a flow diagram illustrating a method of verifying a node of an integrity tree.

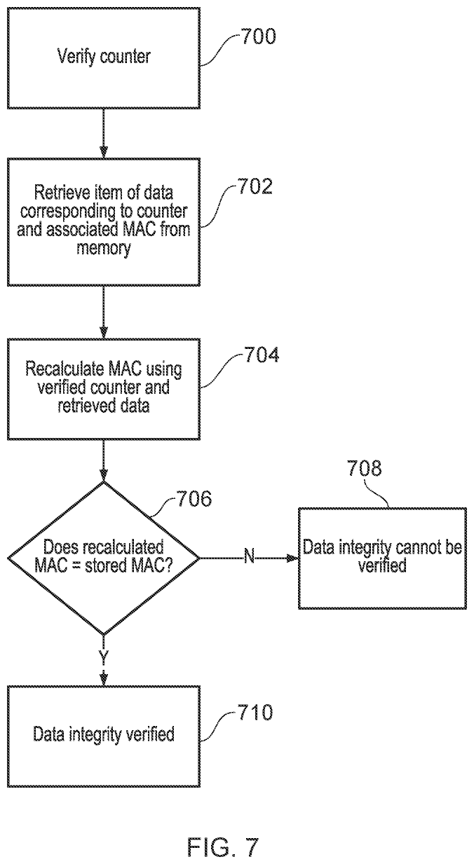

FIG. 7 is a flow diagram illustrating a method of verifying data using a counter.

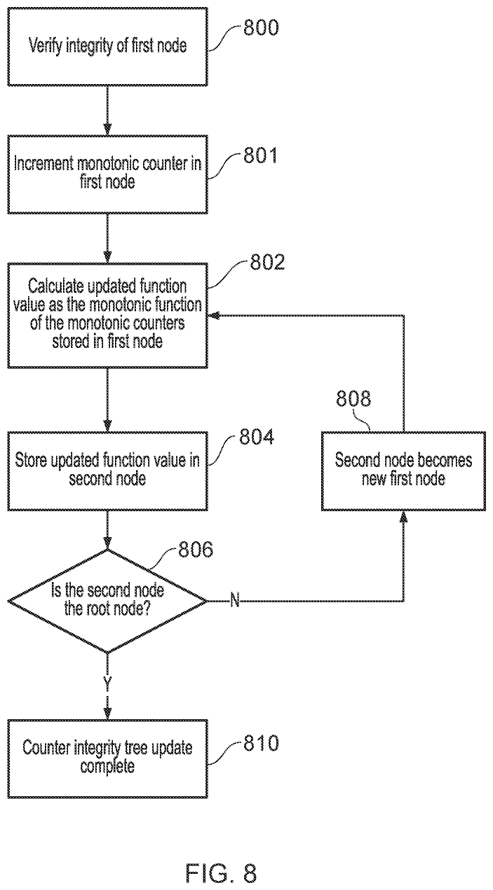

FIG. 8 is a flow diagram illustrating a method of updating a counter integrity tree.

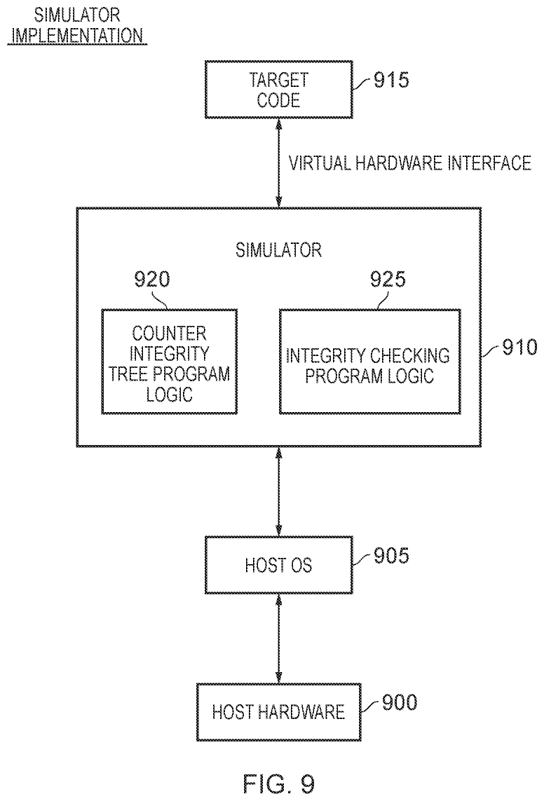

FIG. 9 schematically illustrates a simulator implementation.

A data processing apparatus may store counters. The counters may be non-repeating counters, where a non-repeating counter is one which, when updated, takes a value that the counter has not previously taken. A monotonic counter is an example of a non-repeating counter, where a monotonic counter is a counter which only changes in one direction. For example, a monotonic counter may only be incremented but never decremented (or vice versa). In this way, when the value of a monotonic counter is updated, the updated counter value is guaranteed to be a new, previously unseen, value. It will be appreciated that there are other examples of non-repeating counters (e.g., a counter which is updated to a random or pseudo-random value from a set of previously unused values). Certain binary numeral systems may be non-repeating because they are monotonic counters in a particular representation, such as Gray code (which in one interpretation counts linearly, but when interpreted as traditional binary would appear not to count linearly but would nevertheless not repeat) or a generator in a GF(2\hat{ }n) field. Non-repeating counters have a wide range of uses in data processing devices. For example, non-repeating counters can be used to prevent replay attacks when generating authentication codes for protecting the integrity of data stored in a non-trusted memory. Non-repeating counters can also be used to generate unique identifiers, for example when generating transaction identifiers such as those used during the electronic transfer of funds.

The apparatus may store a large number of counters. For example, when used to protect the integrity of data a counter may be provided per item of data to be protected. If there is a large address space to be protected, there may be a correspondingly large number of counters provided. Therefore, there may be a requirement for a large amount of storage to store the counters. In some examples, this storage could be provided by trusted memory, such as on-chip memory on the same integrated circuitry as the circuitry using the counters. However, often the capacity to hold data in a storage unit which is less vulnerable to an attacker, such as the on-chip memory, may be limited. Hence, in practice it may be required to store at least some of the counters to memory which is more vulnerable to an attack, such as off-chip memory. Storing the counters in non-trusted (or less-trusted) memory puts the counters at risk of being modified by an attacker, which may affect the data processing controlled by those counters (such as data integrity checking or transaction ID generation). Therefore, the counters may be subjected to integrity verification when read from memory.

In some examples, the integrity verification may depend on a comparison between a stored counter and integrity metadata corresponding to that counter. For example, when writing a counter to the memory, integrity checking circuitry could generate the integrity metadata based on the counter stored to memory, and then when reading the counter from the memory, the previously stored integrity metadata can be used to check whether the counter has changed since it was written. Such integrity metadata can require a significant amount of storage space to provide all the metadata for protecting the counters. Hence, in practice it may be required to store at least part of the integrity metadata to the same memory which is storing the counters to be protected. This may make the metadata vulnerable to an attack, so the integrity metadata may itself be subjected to integrity verification when it is read, in a similar way to the counters of interest, based on further metadata which may also be stored in the memory. To manage a series of integrity checks for the counters and each piece of integrity metadata required for verifying the counters, it can be useful to represent the metadata as an integrity tree comprising a number of nodes, where a root node can be used to verify a number of branch nodes that are child nodes of the root node, each of those branch nodes can then be used to verify further branch nodes which are child nodes of those earlier branch nodes, and so on until a node is reached which stores a counter to be protected by the integrity tree. In some cases, the nodes to be protected by the integrity tree are stored in the leaf nodes of the integrity tree.

In one example, the integrity metadata could comprise a message authentication code (MAC) generated based on a selection of counters to be protected and a further counter for preventing replay attacks. The MAC could be stored in the same node as the counters which it protects. The further counter, which is used in the generation of the MAC and therefore also used in the integrity checking, may then be stored in a parent node and itself be protected by a further MAC, and so on until there are few enough counters to store in trusted memory. When counters are retrieved from memory, a MAC could be recalculated using the retrieved counters and the counter stored in the parent node, and the recalculated MAC can be compared against the stored MAC to determine whether the counters have been modified. The counter stored in the parent node prevents replay attacks by ensuring that an attacker cannot replace a set of data and a MAC with a previously valid set of data and MAC because a previous MAC would only be valid when using an old value of the parent counter. In this example, the integrity metadata comprises both counters and a MAC. The MAC may require a significant amount of storage space. In one example storing counters in a 64-byte block, 64 bits may be spent on the MAC, meaning that ⅛ of the memory consumed by the tree is used for the MAC. If the technique did not require a MAC, either: the bits used to store the MAC could be removed reducing the storage requirements of the tree, or the storage previously used for the MAC could instead be used to store additional counters and the arity of the tree could be increased, reducing the height of an integrity tree and therefore reducing the overhead of traversing the integrity tree. Hence, it would be desirable to provide a counter integrity tree without the use of MACs.

The inventors have realised that a counter integrity tree storing non-repeating counters can be provided without the need for MACs.

As used herein, a non-repeating function of non-repeating counters is a function which, when any of the non-repeating counters is updated (to a value not previously taken by that counter), produces an output that has not previously been seen (i.e., the output of such a function does not repeat). If one of the inputs to a non-repeating function of non-repeating counters were modified to a previously observed input, the output of the non-repeating function would change. When the inputs to the non-repeating function of non-repeating counters take a given set of values, then in order for the inputs to be modified without affecting the output of the function, one of the inputs would need to be modified to a previously unseen input (because by definition all of the previously seen inputs produce a different output to the output produced by the given set of values). Whether or not a given function is a non-repeating function for a particular set of non-repeating counters may depend on the form of the non-repeating counters.

An example of a non-repeating function of non-repeating counters is a monotonic function of monotonic counters. A monotonic function is one which only changes in one direction when its operands are changed in one direction. For example, as used herein a monotonic function may be defined as ƒ(xᵢ⁰)≤ƒ(xᵢ¹) where xᵢ⁰≤xᵢ¹ (or vice versa). This definition includes functions of multiple variables, e.g., ƒ(x₁⁰,x₂⁰)≤ƒ(x₁¹,x₂¹) when x₁⁰≤x₁² and x₂⁰≤x₂¹. As described above, a monotonic counter is a counter which is either: only incremented, or only decremented (i.e., it is only updated in one direction). A monotonic function of monotonic counters is therefore itself a monotonic counter, as it will only change in one direction when its operands are updated, because the operands will only change in one direction. Monotonic counters and a monotonic function provide a useful example of the non-repeating counters and non-repeating function, as monotonic counters may be simple to implement in hardware and enable several different functions to be used as a non-repeating function (such as addition or multiplication of the operands).

Another example of a non-repeating function of a non-repeating counter is Galois field multiplication when the non-repeating counter is a generator in a GF(2\hat{ }n) field.

The apparatus comprises counter integrity tree circuitry configured to maintain a counter integrity tree comprising a plurality of nodes with the relationship as discussed above. In such a tree, the parent node of a given node is the node containing integrity metadata for the given node which is closer to the root node than the given node, and a child node is any node closer to a leaf node than the given node for which the given node contains integrity metadata. Therefore, two nodes may be in a parent child relationship when one of the nodes (the parent node) contains integrity metadata for the other (the child node) and where the parent node is closer to a root node and the child node is closer to a leaf node. It will be appreciated that the use of the term “closer” refers to the position of a node in an integrity tree and does not imply anything about the position that the nodes are stored in memory.

The counter integrity tree circuitry is configured to store in a first node of the counter integrity tree a representation of two or more non-repeating counters. The counter integrity tree circuitry is also configured to store in a second node of the counter integrity tree, which is a parent node of the first node, an indication of a function value equal to a non-repeating function of the two or more non-repeating counters of the first node. The apparatus also comprises integrity checking circuitry to check the integrity of the first node using the function value retrieved from the second node. Hence, the integrity metadata comprises a non-repeating function of the non-repeating counters of the second node. If the non-repeating counters stored in the second node were modified, then it is expected that the non-repeating function of the two or more stored non-repeating counters would change. Hence, the integrity checking circuitry would be able to identify that there has been a modification to the non-repeating counters.

Compared to the case discussed above using MACs and counters, this technique can provide integrity by only storing counters (the non-repeating counters and the function value, itself a non-repeating counter) at each level of the tree. Hence, the integrity of the counters can be provided without the need to provide MACs. This provides a particularly efficient counter integrity tree which can require less storage capacity or, for a given size, can have a greater arity than techniques using a MAC.

If the counters were unencrypted in memory, there could be a possibility for an attacker to modify the counters whilst leaving the non-repeating function of the counters unchanged. For example, when the non-repeating function of non-repeating counters is a sum of monotonic counters, then an attacker could decrement one counter and increment another counter by the same amount when both counters are inputs to the same function value, leaving the sum of the counters unchanged. When the non-repeating function is a sum, then if one counter is decremented it is expected that the output of the sum would decrement, hence the need to increment a different counter which is also an input to the sum in order to leave the output unchanged. It will be appreciated that similar considerations apply to all non-repeating functions, and that a sum has been chosen in this instance for illustration.

In order to make this attack more difficult, the counter integrity tree circuitry stores an encrypted representation of the two or more non-repeating counters to the first node. Even if the counters are encrypted, in some cases an attacker may be able to infer the plaintext value of a given counter. For example, counters may be incremented each time the counter is accessed (if they are monotonic, for example). By monitoring the data accesses of an apparatus, an attacker may be able to infer the value of any given counter. Hence, the attacker may in some cases be able to form a dictionary recording the mapping between a plaintext counter (as calculated by the attacker) and an encrypted counter (as stored to memory). However, even having this dictionary an attacker may not be able to modify the values of the first node in a way which does not modify the non-repeating function of the counters. This is due to the definition of the non-repeating function. When the inputs to the non-repeating function of non-repeating counters take a given set of values, then in order for the inputs to be modified without affecting the output of the function, one of the inputs would need to be modified to a specific previously unseen input. This means that a particular value which is not stored in the dictionary would be needed, and therefore a value for which the attacker does not know the encrypted representation (even if they know what the plaintext counter should be).

For the example of a sum of monotonic counters, if one counter were to be decremented, then another would need to be incremented to keep the monotonic function of the counters unchanged. Whilst the dictionary could allow the attacker to decrement a counter (because it would store the encrypted version of a previous counter value) it may not allow the attacker to increment a counter because the dictionary would not store an incremented version of that counter. This is because the counters are monotonic, and therefore an incremented version of the counter is an unseen value, and therefore the attacker may not know what the encrypted representation of the incremented counter would be.

The attacker may therefore be unable to modify the counters in a way which would keep the value of the non-repeating function of said counters unchanged because this would require them to know what the encrypted representation of a particular previously unseen value would be, and this information may be difficult (or impossible) to obtain. Hence, because the counters are non-repeating (meaning that updated versions of counters are previously unseen) and because the function is a non-repeating function (meaning that to modify the counters leaving the function value unchanged an attacker is expected to need an unseen value of a counter), then storing encrypted representations of the counters is sufficient to allow a function value calculated using the non-repeating function to be used for integrity checking.

It is noted that, in practice, given a long enough execution time certain counters may repeat. For example, a counter may be reset to an initial value after reaching a final value, where attempting to increment the counter after the final value may trigger an overflow. A monotonic counter may be reset after reaching an “all ones” value, for example, although the final value may not always be “all ones”. After being reset, when the counter is incremented it may repeat values that it has previously taken (before being reset). However, it will be appreciated that, even in a practical implementation, measures can be taken to ensure that counters do not repeat. For example, the counters could be made large enough that they do not overflow within the design life of the system, and therefore in practical terms may be considered a “non-repeating counter”. Alternatively, or in addition, if a counter is about to overflow (which may lead to repetition), then this could be detected and certain actions could be taken. In one example, when it is detected that a counter is about to overflow, the non-repeating function of non-repeating counters could be modified, or alternatively a key used to encrypt the counters could be updated (such that non-repeating counters are non-repeating in the context of a specific key). In a second example, a fault could be indicated when it is detected that a counter is near to overflowing. Therefore, even counters which may eventually repeat in practice can be treated as non-repeating counters for the purpose of the counter integrity tree.

In some examples, the integrity checking circuitry may check the integrity of the second node in dependence on a root value retrieved from a protected root node. For example, the root value may be directly used to verify the integrity of the second node. Alternatively, additional nodes between the root node and second node may be verified in dependence on the root value and then the second node may be verified in dependence on the intervening nodes. This may allow the second node to be trusted so that integrity checking of the first node in dependence on the second node can provide a trusted check of the integrity of the first node.

The first node and the second node may be any pair of nodes having a parent child relationship within a counter integrity tree. The leaf nodes of the integrity tree may store the counters to be used by circuitry for data integrity or transaction ID generation, for example. In one example, the first node of the counter integrity tree is a leaf node storing these counters as the two or more non-repeating counters. The second node may then be a parent node of the leaf node. In some examples, both the leaf node and the parent node of the leaf node are stored in non-trusted memory. The function value stored in the parent node is used by integrity checking circuitry to verify the integrity of the counter values stored in the leaf node. The parent node may then be protected by further integrity values at higher levels of the counter integrity tree. However, there is no requirement for the first node (the node to be protected by the second node) to be a leaf node of the integrity tree. In some examples, the parent node of the leaf node may be the first node, and the second node may be a grandparent node of the leaf node, or any pair of nodes may be the first and second nodes.

In some examples, the first node is stored in non-trusted memory as the highest-level node of the integrity tree stored in non-trusted memory. The second node may then be stored in trusted memory, and the function value stored in the second node may be used to verify the integrity of the first node. In this example the second node does not need to be verified because it is stored in trusted memory, and the second node may therefore be considered the root node of the counter integrity tree. Whilst the term “non-trusted” has been used, it will be appreciated that the non-trusted memory may have some level of trust (for example, access to the non-trusted memory may be controlled based on page tables) and may alternatively be referred to as less-trusted memory, trusted less than the “trusted” memory (which may therefore be referred to as more-trusted memory). The non-trusted memory may be off-chip memory, and the trusted memory may be on-chip memory.

In some examples, the integrity checking circuitry checks the integrity of the first node by retrieving the counter values stored in the first node and generating a decrypted representation of the two or more non-repeating counters by decrypting the encrypted representation of two or more non-repeating counters retrieved from the first node. The integrity checking circuitry may then calculate the non-repeating function of the two or more non-repeating counters of the decrypted representation, evaluating the non-repeating function having the retrieved non-repeating counters as inputs. Then, the integrity checking circuitry can compare the calculated function value which is the non-repeating function of the retrieved counters with the stored function value retrieved from the second node. It is noted that the stored function value may be encrypted when stored to the second node. For example, an indication of a function value may comprise an encrypted representation of the stored function value. Therefore, retrieving the stored function value may comprise decrypting the stored function value. The stored function value is the non-repeating function of the counters as they were stored to memory (assuming that the stored function value itself has not been modified—if it has then this will be identified in the integrity checking of the second node). If the two values match, then it can be determined that the counters have not been modified, because if they had then the calculated function value would be different to the stored function value. An attacker could modify a counter value using a previously seen value but only using previously unseen values would cause the output of the non-repeating function to change. The attacker may not be able to update a counter value using a previously unseen value as they should not be able to know the encrypted version of a previously unseen counter value. An attacker could attempt to guess the encrypted value of a previously unseen counter value, but this would have a very low chance of success with counters of a reasonable size.

As mentioned previously, the function value which is the output of the non-repeating function of two or more non-repeating counters it itself a non-repeating counter. That is, its updated value will always be a previously unseen value as its operands are updated. It is not necessary for the function value to change by the same amount each time it is updated, and hence the function value is not necessarily a linear counter, but the function value is nevertheless a non-repeating counter. Each time the non-repeating function of the non-repeating counters is updated (when the non-repeating counters are updated), the new value will be a value that has not previously been taken by the non-repeating function.

Because the non-repeating function is itself a non-repeating counter, the relationship between a given node and its parent node is equivalent to the relationship between the parent node and its parent node (the given node's grandparent node) because in each case the child node stores non-repeating counters and the parent node can store a function value which is the non-repeating function of non-repeating counters. This allows the definition of the first and second nodes to generalise to any parent and child pair of nodes in the tree.

The non-repeating function of non-repeating counters is not particularly limited. As long as the function satisfies the property that when any of the non-repeating counters is updated, it produces an output that has not previously been seen, then any function can be used. When the non-repeating function of non-repeating counters is a monotonic function of monotonic counters, then one example of such a function is the product of the monotonic counters, y=Πᵢ₌₁ⁿxᵢ (where the monotonic counters may be restricted to having the same sign). However, a monotonic function that is particularly efficient to implement is a weighted sum. A weighted sum may take the form y=Σᵢ₌₁ⁿaᵢxᵢ where xᵢ are the operands (the monotonic counters in the present case) and aᵢ are the weights, which may be restricted to all have the same sign (i.e., all positive or all negative values). It can be seen that when the weights are positive and the operands are increased, this function can only increase in size. Therefore, when the operands are monotonic counters which can only increase (or, equivalently, decrease) it will be seen that the weighted sum can only increase (or decrease if the counters can only decrease). For example, if the monotonic counters are A=4 and B=5 and each can only increase, then the function f(A,B)=A+B=9 can only increase when the operands are updated (and hence must take a value that has not previously been seen, therefore satisfying the requirements of a non-repeating function). Hence, the weighted sum is itself a monotonic counter. It will be appreciated that the weights could each take the value 1 and the weighted sum could be a simple sum of the monotonic counters. The weighted sum is particularly simple to implement in logic, and the function value resulting from the operation will be similar in size (a similar order of magnitude) to the operands (as compared to, for example, a product function between the operands where the function value is likely to be much larger than the operands) which allows similar size counters to be used at different levels of the integrity tree.

As discussed above, it is difficult for an attacker to modify the counters whilst keeping the function value unchanged by updating counters to specific previously unseen values. However, an attacker may try to modify a given node by swapping it with a different node having the same function value. An attacker may also swap counters within the same node, changing the value of a given counter whilst seeking to leave the overall function value unchanged. Also, an attacker could seek to anticipate the encrypted version of a given updated counter by observing the encrypted values of different counters when they are updated in the same way. These attacks can be made more difficult by using an index of a node or a sub-block of counters as an additional input in the encryption operation for encrypting the two or more non-repeating counters. The encryption operation may take an additional value as an input in one of several ways. For example, a key-derivation function for generating a key used in the encryption operation could take the additional value as an input when generating the key. Alternatively, a cipher could take the additional value as a direct key-like input in the encryption operation.

In some examples, the two or more non-repeating counters of the first node are encrypted in a single encryption operation. The encrypted representation of the two or more counters may no longer be distinguishable as separate counters, and therefore an attacker may not be able to learn the encrypted representation of a given plaintext counter value. However, a block of counters could potentially be swapped with another block of counters that has the same function value but different decrypted counters. A tweak is an additional input in an encryption operation (which is also used in the corresponding decryption operation), which may be used to modify the ciphertext produced by performing the encryption operation on a given item of plaintext. By using an index of the node as a tweak in the encryption operation, then if nodes are swapped to different locations in memory, when they are decrypted by the integrity checking circuitry the wrong index will be used in the decryption operation and the decrypted counter values will not have the stored values corresponding to the stored function value. Therefore, the function value that is calculated from the decrypted counter values will not match the stored function value and the integrity check will fail. Hence, using the index of the block as a tweak prevents blocks of counters from being swapped between nodes of the integrity tree. The index could be a unique value assigned to each node and may include an address of the node or a part of the address of a node, for example.

In some examples the two or more non-repeating counters are encrypted in two or more separate encryption operations each encrypting a sub-block of non-repeating counters of the first node. For example, a sub-block could contain a single non-repeating counter or could contain several non-repeating counters. If the non-repeating counters are encrypted separately, then an attacker may be able to form a dictionary between inferred plaintext counters and observed ciphertext (encrypted) counters as discussed above. If the counters all had the same relation between plain and ciphertext, then the encrypted representation of one incremented counter may be determined by observing the ciphertext of another counter that has already been incremented. In some examples an index of a given sub-block is used as a tweak in the encryption of that given sub-block. This means that counters in different sub-blocks have a different relationship between plain and ciphertext representations and therefore observing any one counter cannot provide an attacker with information about the future state of any other counter. The index of the sub-block could be the global address of the sub-block, for example.

In another example, an address may not need to be used in the encryption operation for a given counter. Instead, the counter integrity circuitry may initialise the counter tree by setting the two or more non-repeating counters to initial counter values, wherein the initial counter values are randomly selected. It will be appreciated that pseudorandom values can be used in the place of true random values. By setting the initial counter values to random values, it is much harder for the attacker to use one counter to predict the future value of another counter because the counters are likely to take significantly different values from each other and therefore it is less likely that any counter will have previously taken the updated value of a given counter.

For example, when the counters are monotonic, it is unlikely that another counter will have previously taken the given counter value plus M and a different counter minus M (which are the values needed to decrement and increment counters whilst keeping the function value unchanged for the unweighted addition function—similar considerations apply to different functions). For example, if counter A is to be incremented and counter B is to be decremented to leave the function value unchanged, the attacker would need to know the encrypted representations of A+M and B−M. For illustration, M can be taken to be 1. However, if the initial plaintext counter values were (for illustration only) A=1372, B=2576, and C=3112 and so on, then the attacker is very unlikely to have seen the encrypted representation of A+1=1373 (as the other counters have very different values and A will have never previously taken this value because it is a monotonic counter) and therefore it is made more difficult for the attacker to know what value to update the counter A to. Eventually the counters may overlap, but this could be made rare with large counter values.

As discussed above, there are no particular limitations to the use of the counters protected by the tree. However, a particularly useful implementation of the counter tree is for storing protected non-repeating counters for checking the integrity of data stored in non-trusted memory. When on-chip memory is limited, a large amount of data may be stored to non-trusted memory. Data integrity counters may be provided at a fine granularity that means that there may be a large number of counters for ensuring the integrity of data stored in non-trusted memory. For example, data integrity may be provided at a granularity of a cache line. Examples of the present technique provide a counter tree which can be used to store the counters in non-trusted memory. In addition, examples of the present technique provide a particularly efficient method for providing a counter tree in which it is not required for each node to store a MAC. The present technique allows nodes of a given size to store a greater number of counters than in alternative techniques, or for a given number of counters allows the nodes to be reduced in size. Therefore, the technique allows either: the arity of the tree to be increased (and the height of the tree to be reduced, when more counters are provided per node enabling quicker tree traversal) or the storage requirements of the counter tree to be reduced. These effects are particularly advantageous when the tree is used to store data integrity counters because: quicker tree traversal allows the integrity of data retrieved from memory to be checked more quickly, and due to the large number of counters used for data integrity checking the reduction in storage requirements can be significant.

In addition, the cryptographic operations for verifying and updating nodes of the counter integrity tree may be performed in parallel. For example, the first and second nodes may be decrypted in parallel. This can enable a tree to be traversed more quickly than certain other structures where tree operations need to be performed in dependence on others, and therefore where tree operations cannot be parallelised.

There are no particular limitations on how a non-repeating counter may be used for data integrity checking. However, in one example a protected non-repeating counter is used to check the integrity of an item of data retrieved from the non-trusted memory based on a comparison between a stored authentication code and a generated authentication code (MAC) generated based on the item of data and a corresponding decrypted non-repeating counter of the two or more non-repeating counters retrieved from the first node. That is, when an item of data is stored to memory a MAC is generated using the data and a counter value, which may be incremented each time data is stored to memory. The MAC is then stored to non-trusted memory with the item of data. Upon retrieval of the data from memory, the counter value is retrieved from the counter tree (and its integrity is checked using the function value stored in a parent node, which may itself have its integrity checked using a further function value, and so on), and the counter value and the retrieved item of data are used to regenerate a MAC. If the data has not been modified, then the regenerated MAC should be identical to the MAC that was generated when the data was stored to memory. To check whether this is the case, the regenerated MAC is compared to the MAC retrieved from non-trusted memory with the item of data.

As described above, the present technique may enable nodes in a counter tree to be protected from modification (by allowing modification to be identified) in a way that does not require the storage of a message authentication code in the counter integrity tree. Whilst some nodes of the tree may nevertheless use MACs (not every level of the counter integrity tree needs to use the method of storing a function value in the parent node), the present technique enables a counter integrity tree to be implemented in which there are no MACs stored at any node of the tree. The storage that would otherwise be used to store a MAC for protecting a node of a tree can be reused for more counters or can be eliminated to save space. MACs can be removed from the counter tree because the role of a MAC (identifying modifications to counters in a child node) can be achieved using a counter in the parent node when the counter in the parent node is calculated from a function of the counters in the child node.

The encryption operation for encrypting the two or more non-repeating counters of the first node is not particularly limited. As discussed above, in some examples the encryption operation could take certain additional values (other than the counters themselves) as an input (a tweak, such as the address of a node or of a counter within a node), and therefore the encrypted representation of the counters could depend on the plaintext values of the counters, a key, and the tweak, for example. Any one of several encryption techniques could be used to encrypt the entirety of the node. However, in some examples the encryption operation encrypts the two or more counters by encrypting sub-blocks of the node. The node may store more bits than can be encrypted in a conventional encryption operation. For example, the node may store more than the 128 bits used in the AES block cipher. Hence, the node can be subdivided into sub-blocks (of a size which may be equivalent to the block size of a conventional block cipher) and each sub-block can be encrypted separately. In some examples, the encryption operation encrypts a given sub-block such that when one bit of the encrypted representation of the given sub-block is changed, more than one bit of the decrypted representation of the given sub-block changes. In some examples, the encryption operation encrypts a given sub-block such that when one bit of the encrypted representation of the given sub-block is changed, on average half of the bits of the decrypted representation of the given sub-block change. This property is sometimes known as diffusion. When the encryption operation is defined in this way, the relationship between the plaintext counters and the ciphertext counters (the encrypted representation of the counters) is obfuscated. Therefore, patterns in the plaintext should not be apparent in the ciphertext. In examples of the technique, the counters are incremented meaning that successive values of a counter are likely to have very similar plaintext values. By using an encryption operation with the above properties, it becomes much harder to predict the encrypted representation of a future counter based on a previously observed encrypted representation of the counter, and therefore attacks involving incrementing a counter to a previously unseen value become more difficult. In some examples, the diffusion property may apply across an entire node in addition to within a sub-block.

In some examples of the technique, a given node could be decrypted in dependence on a value stored in a different node. However, in examples of the technique the counter integrity tree circuitry may be configured to decrypt the encrypted representation of the two or more non-repeating counters without using a value derived from another node in the counter integrity tree. This allows different nodes to be encrypted and decrypted in parallel. For example, for verifying the integrity of a given leaf node of the tree, each node from a protected root node on the path to the leaf node (the leaf node's parent node, grandparent node etc.) may need to be verified. If these can be decrypted in parallel, then the verification of the leaf node can be performed more quickly than if they were decrypted in dependence on one another. Hence, operations requiring a verified counter (such as data integrity verification or transaction ID generation) can be performed more quickly when nodes of the tree can be decrypted without using a value derived from another node in the tree.

In some examples, the counters are stored in a node independently. For example, the decrypted representation of the counters may comprise a number of bits separated into sections wherein each section corresponds to a single independent counter. However, certain bits of the counters (such as the most significant bits) may often be the same between several counters of the tree. For example, if all counters start at 0, the most significant bits of every counter will start with the same value. Representing the same bits in each separate counter may therefore be inefficient. An alternative is to use split counters, in which each counter comprises the combination of a major counter and a minor counter. For example, the bits of the major counter may represent the most significant bits of the counter and the bits of the minor counter may represent the remaining bits of the counter. The major counter can be shared between several minor counters, meaning that the storage requirement for storing the bits represented by the major counter can be reduced.

When a minor counter reaches its maximum value and is incremented, it may be reset to its minimum value and the corresponding major counter may be incremented. However, this means that the reset minor counter takes a value it has taken in the past. Therefore, whilst the overall counter (a combination of the major and minor counter) may be non-repeating, the minor counter itself may not be non-repeating. This may present an opportunity for an attacker to update a minor counter (using a previously seen encrypted minor counter value) and therefore update the overall counter to a known value even though the incremented version of the overall counter has not been previously seen. The basic use of split counters could therefore allow an attacker to modify counters whilst leaving the function value of said counters unchanged by updating a counter to a previously unseen value (e.g., decrementing one counter to a previously seen value and incrementing another counter to a previously unseen, but inferred, value). However, in examples of the present technique the counter integrity tree circuitry may apply an encryption algorithm which ensures that the encryption of each minor counter takes as an input the value of the major counter. This means that the encrypted version of each minor counter is different when the major counter is different. Therefore, an attacker can observe the encrypted versions of each value of the minor counter for a given major counter, but when the minor counter is reset (and therefore the major counter is updated), the encrypted versions of the reset minor counter will not be the same as the previously observed encrypted versions of the minor counter. Hence, even observing every possible value of the minor counter for one major counter value may not allow an attacker to perform an attack, because they should not know a future encrypted representation of a minor counter after the major counter has been updated.

In some examples, the encryption operation is applied to sub-blocks of the node, as introduced above. In some examples, the major counter may be stored in one sub-block, which may also include a number of minor counters. Other sub-blocks may then contain only minor counters, and therefore the sub-blocks containing only minor counters may not be non-repeating as discussed above. In examples of the technique, the encryption operation for creating an encrypted representation of a given sub-block which contains only minor counters can be arranged to take as an input the value of the major counter (the encryption of each minor counter sub-block is tweaked with the value of the major counter). This provides a particularly effective technique for using the major counter as an input in the encryption of each minor counter.

In the examples discussed above, it has been described how the present technique enables a node of a counter integrity tree to be provided with counters. However, the node is not necessarily limited to only store counters. In some examples, the counter integrity tree circuitry is configured to also store, in the first node, a representation of metadata. Metadata could be any data which may relate to a node, but which is not a non-repeating counter. In order to protect the metadata from modification when the node is stored in the non-trusted memory, the function value may be equal to the non-repeating function of the two or more non-repeating counters and the metadata. Then, if the metadata is modified, the function value will change (in the same way as if the counters were modified) and the modification can be identified.

It has been discussed above how the present technique enables the integrity of counters to be checked with a function value when the counters used to generate the function value are non-repeating. If the node also stores metadata, the integrity tree circuitry may be required to store the metadata in a way that ensures that inputs to the non-repeating function do not repeat. Metadata, unlike a counter, is often not updated in a non-repeating manner. There is not usually a restriction on metadata that the value represented by its bits must not repeat when the metadata is updated. Modifications to the metadata could lead to the inputs of the function value taking a value they had previously taken.

Therefore, in some examples, the counter integrity tree circuitry determines whether the new value of the metadata is a value that has previously been seen. If the value is previously unseen, then the update could be made to the metadata, but if the update is to a previously seen value, then the update may cause the overall value of the given counter and metadata to take a previously seen value. It is undesirable for the value of the counter and metadata combination to take a previously seen value, therefore in some examples when it is detected that the metadata is updated to a previously seen value then the counter circuitry may update the counter to ensure that the combination of counter and metadata is a new value. However, this may require a significant amount of storage in order to store a representation of the previous metadata values. In another example the counter may be updated each time the metadata is updated, such that the combination of metadata and counter is guaranteed to be new (because the data stored in the node would be a tuple of (metadata, counter) stored as “metadata II counter” (with II being the concatenation operator), and if the counter is always updated when the metadata is updated, then regardless of the value of the metadata the value of the tuple must be new).

In some cases, the first and second node of the counter integrity tree may be the only pair of nodes using a non-repeating function value in a parent node to protect non-repeating counters in a child node. Other nodes could be protected using a MAC or other techniques. For example, leaf nodes could be protected using a MAC, but their counters protected using a non-repeating function. However, in other examples each node of the counter integrity tree other than a protected root node may be stored in the non-trusted memory. Each node other than a protected root node may store an encrypted representation of two or more non-repeating counters. A parent node of each node other than the protected root node may store, for each child node, an indication of a function value equal to the non-repeating function of the two or more non-repeating counters of that child node. The integrity checking circuitry may be configured to check the integrity of a given node using the function value retrieved from the parent node of the given node. Hence, the technique can be generalised to several levels in a counter integrity tree. In this case, a given parent child pair of nodes can be considered the first and second node discussed above. The technique is particularly suited to generalising to several levels because the function value may itself be a non-repeating counter, and hence a node storing several function values for its child nodes is a node storing two or more non-repeating counters.

Particular configurations of the present techniques will now be described with reference to the accompanying figures. For the purposes of the following description, monotonic counters are used as examples of non-repeating counters and a monotonic function of the monotonic counters is used as the non-repeating function of non-repeating counters.

FIG. 1 schematically illustrates an example of a data processing system 2, which comprises an integrated circuit or system-on-chip 4 which includes at least one processor core 6 for executing program instructions to carry out data processing operations. While FIG. 1 only shows one processor core in some cases the system-on-chip 4 may comprise multiple processors. Each processor core or processor core cluster may have a cache 8 (or multiple levels of cache 8, 10). A memory controller 12 acts as memory access circuitry for controlling access to an off-chip memory 14 which is on a separate integrated circuit from the system-on-chip 4. While accesses to data on-chip may be difficult to tamper with by an attacker, the edge of the system-on-chip may act as a trust boundary and any data passing beyond that boundary may be vulnerable to attack by intercepting data on the physical channel 16 between the memory controller 12 and the off-chip memory 14, or by reading or modifying the data while it is stored in the off-chip memory 14. While FIG. 1 shows an example where the trust boundary corresponds to the edge of the system-on-chip, in other cases there could be trust boundaries within a system-on-chip which could expose data beyond the trust boundary to potential attacks.

The system-on-chip 4 may include a memory security unit 20 provided for protecting counters or data stored to a protected memory region 22 of the off-chip memory 14 from a malicious adversary who has physical access to the system and the ability to observe and/or replay the data or code being exchanged between the microprocessor and the off-chip system memory 14. The protected memory region 22 may include data 24 to be protected as well as a counter integrity tree 26 used to verify a set of counters, which may then be used in the verification of the data 24. An unprotected memory region 28 may also be provided in the off-chip memory 14, and data 30 stored in the unprotected region is not protected by the memory security unit 20 and so is free to be accessed and modified by an attacker. In some implementations, the mapping of addresses to the protected and unprotected memory regions 22, 28 may be fixed by the hardware, so that it is not possible for an operating system or other software executed by the processor core 6 to vary which addresses are mapped to the protected memory region 22 or unprotected memory region 28. Alternatively, if the software controlling the address mapping can be trusted, the address mapping controlling which addresses are mapped to the protected region or the unprotected region may be varied by the processor under control of software, and so the protected and unprotected regions need not always map to the same physical locations in the off-chip memory 14. In some implementations, there may not be any unprotected memory region 28 provided in the off-chip memory 14—in this case the entire off-chip memory could be considered the protected memory region 22.

The memory security unit 20 includes encryption/decryption circuitry 32 for encrypting data 24 and counters of the integrity tree 26 being written to the off-chip memory 14 and decrypting data and counters read back from the off-chip memory. This provides privacy by preventing a malicious observer from seeing in the clear the data being read from or stored onto the off-chip memory 14. Encryption keys used by the encryption and decryption may be stored within an on-chip memory (e.g., SRAM) 34 on the system-on-chip or within the memory security unit 20 itself. Any known technique may be used for the encryption and decryption, and any known approach for protecting the encryption keys can be used. The memory security unit 20 and the circuitry included in the memory security unit 20 may be referred to generally as counter integrity tree circuitry, which may in some examples also include the memory controller 12.

The memory security unit 20 also includes integrity tree generation and verification circuitry 36, referred to in general as verification circuitry 36 or integrity checking circuitry below. The verification circuitry 36 is responsible for maintaining the integrity tree 26 in the protected memory region. The integrity tree may provide a number of pieces of information for verifying whether counters currently stored in the integrity tree 26 are still the same as when they were written to that region. In addition, the protected counters stored in the integrity tree may be used to check the integrity of data stored in the protected region 22 of the integrity tree. The checking of data integrity can for example be achieved using algorithms which make it computationally infeasible for an attacker to guess the authentication code associated with a particular data value by brute force when a secret key used to generate the authentication code is unknown. For example, Cipher-based Message Authentication Code (CMAC), Hash-based Message Authentication Code (HMAC), or encrypted universal hash function (UHF) algorithms could be used to generate a MAC. The authentication codes may be stored alongside the data 24 in the protected memory region 22 or in a separate data structure. The stored MAC for a data value is checked against a calculated MAC derived from the stored data using the same function used to generate the stored MAC, and if a mismatch is detected between the stored MAC and calculated MAC then this may indicate that the data has been tampered with.

However, providing MACs alone may not be sufficient to prevent all attacks. Another type of attack may be a replay attack where a malicious person with physical access to the system stores a legitimate combination of the encrypted data and the MAC which was observed previously on the bus and then replays these onto the bus later with an intent to corrupt data at a given memory location with stale values so as to compromise the operation of the system. Such replay attacks can be prevented using the integrity tree 26, which may provide a tree structure of nodes where each leaf node of the tree provides integrity data for verifying that one of the blocks of data 24 in the protected memory region 22 is valid and a parent node of a leaf node provides further integrity data for checking that the leaf node itself is valid. Parent nodes may themselves be checked using further parent nodes of the tree, and this continues as the tree is traversed up to the root of the tree which may then provide the ultimate source of verification. Root verification data 38 stored in the on-chip memory 34 may be used to verify that the root of the tree is authentic, either by storing the root node of the tree itself on on-chip, or by storing other information which enables the root node stored in the protected memory region to be authenticated.

The memory security unit 20 may have address calculating circuitry 40 for calculating the addresses at which the nodes of the integrity tree 26 required for checking particular data blocks are located in the protected memory region 22. Optionally, the memory security unit 20 may also have a cache 42 for caching recently used nodes of the integrity tree for faster access than if they have to be read again from the off-chip memory 14. Alternatively, the memory security unit 20 could have access to one of the caches 10 which may also be used by the processor core 6 and so caching of data from the integrity tree 26 within the shared cache 10 could also help to speed up operation of the memory security unit 20.

The integrity tree 26 is not limited to being used for checking the integrity of data 24 in the protected region 22 of the off-chip memory 14. In other examples the processor 6 may use the protected counters stored in the integrity tree 26 for other purposes, such as in the generation of single-use transaction identifiers. The use of a counter for generating transactions IDs ensures that each transaction ID will be unique, and the protection of the counters in an integrity tree means that an attacker cannot trick the processor into reusing an old counter and generating a previously used transaction ID, which could cause errors in a transaction.

FIG. 2 shows an example of implementing an integrity tree. Each leaf node 84 may specify a number of counters. For each leaf node 84 of the tree a MAC 80 is computed based on the contents of the leaf node 84 and a counter 86 read from a non-leaf node 88 which acts as the parent node of the leaf node 84. Each non-leaf node 88 provides the counters used for multiple child nodes 84. Similarly, at each level of the tree, the counter 86 used to compute the MAC 80 for a given child node is read from a data block 88 corresponding to the parent node of that child node, all the way up to the root node 88-R. The address calculating circuitry 40 of the memory security unit 20 identifies, for a given target data block of interest which other data blocks store the required nodes of the integrity tree 26 providing the relevant counters. Eventually, the root node 88-R is reached and the MAC 80 for the root node is computed as a function of the contents of the root node and a root counter 89. The root counter 89 could be stored as the root verification data 38 in the on-chip memory 34. Alternatively, the entire root node 88-R of the tree could be stored in the root verification data in the on-chip memory and in this case there is no need to compute a further MAC for this root node.

A potential use of the counters stored in the leaf nodes 84 is for verifying data integrity. In this example, each data block 50 of the protected memory region 22 which is not part of the integrity tree 26 itself is protected by a MAC 80, which is computed based on the contents of the data block 50 and a counter 82 which is read from a leaf node 84 of the counter integrity tree 26. The leaf node 84 may specify a number of counters each corresponding to different data blocks 50. In this example the MAC 80 calculated for a given data block 50 is stored adjacent to the corresponding data. This is not essential, and in other examples, the MAC could be stored separately from the corresponding data.

In summary, with the counter tree shown in FIG. 2, at each level of the tree the counter's integrity is ensured by using a MAC stored in the same region of memory, the MAC being calculated using a counter read from a parent node of the tree. However, it has been recognised that the storage of a MAC in each node of an integrity tree may be undesirable due to the storage requirements of the MAC. In an example node having 64 bytes of storage, a MAC may occupy 64 bits, and therefore represent ⅛ of the total storage requirements of an integrity tree. If the MAC could be removed, then the number of counters in a node of a given size could be increased. Increasing the number of counters in a node allows each node to be associated with more child nodes (increasing the arity of the tree). When more nodes are associated with each parent node, the overall number of levels in a tree can be reduced. This allows a traversal of the tree to require fewer memory accesses, reducing the amount of traffic associated with accessing an integrity tree and reducing the time to traverse an integrity tree. Alternatively, removing the MAC may allow the nodes to be reduced in size, such that for a given integrity tree the overall storage requirements can be reduced. Both of these advantages can be achieved at the same time in certain cases, with the removal of a MAC both enabling trees to be made shorter and reducing the storage requirements of an integrity tree.

FIG. 3 shows an example of a counter integrity tree that does not require the storage of MACs to protect the integrity of values stored within the tree (although in certain examples MACs could still be used in certain nodes of such a tree). In the example of FIG. 3, each node 84, 88, 88-R stores two or more monotonic counters. The monotonic counters in each node are protected by the integrity tree. The monotonic counters of the leaf node 84 may be used for the protection of data (as shown in a corresponding way to the counters of FIG. 2), but they are not restricted to protecting the integrity of data. The integrity tree protects a large number of counters which can be used in any application making use of counters, such as the generation of transaction IDs.

In FIG. 3, the two or more monotonic counters of a leaf node 84 are used as inputs to a monotonic function 90. The monotonic function 90 outputs a function value which is stored in a branch node 88 which is a parent node of the leaf node 84. The monotonic function satisfies the property that it will only change in one direction when its operands are changed in one direction. For example, when any of the operands of a monotonic function is increased, the monotonic function cannot decrease (or, in an alternative example, cannot increase). Hence, when all of the inputs to the monotonic function are monotonic counters which can only change in one direction, the output of the monotonic function is also a monotonic counter which can only change in one direction. For example, the monotonic function 90 may be an addition operation which outputs the sum of the inputs. If the inputs are monotonic counters which can only increase in size, then the output is a value which can also only increase in size and is therefore also a monotonic counter. The branch node 88 stores function values for a number of leaf nodes 84. Therefore, the branch node 88 stores two or more monotonic counters. When verifying the integrity of a counter retrieved from a leaf node 84, the retrieved values of the counters can be used as inputs in the monotonic function. The calculated value can then be compared to the value stored in the parent node 88 to determine if any of the monotonic counters have been modified. The function value can itself be verified by calculating the monotonic function of the counters in the branch node 88 and comparing the output to the value stored in the branch node 88 that is a parent of that node (88-R in the example of FIG. 3). This process can continue until a root node is reached which can be verified using a value 89 stored in trusted memory (on-chip). The root value may be the monotonic function of the values stored in the highest-level node 88-R, for example. Alternative methods such as the use of a MAC can also be used to protect the highest-level node (which in some examples may store a MAC).

In certain examples described herein, it is assumed that monotonic counters only count up. It will be appreciated that equivalent considerations apply if the counters only count down. Also, it is to be assumed that all of the two or more monotonic counters count in the same direction.

An attacker may attempt to modify a counter in a node of the integrity tree without affecting the function value. If the monotonic function is addition, they may do this by incrementing one counter and decrementing a second counter. The counters are therefore encrypted before being stored in off-chip memory. The attacker may be able to infer the plaintext version of each counter based on the observed number of accesses to the off-chip memory if they are initialised to zero. Then, the attacker can potentially record the encrypted version of each counter (which they can read from the off-chip memory). In this way the attacker can form an association between a plaintext counter value and an encrypted counter value, and store this translation information recording up to the most recently observed counter value (e.g., plaintext counter value=ciphertext counter value: 000=110, 001=111, 010=011, 011=011, 100=??? (not observed), etc.). To perform the attack described above in which a counter is incremented whilst a second counter is decremented, the attacker would need to know the encrypted representation of an incremented counter. The attacker may have observed the decremented version of any given counter, but for a given counter will not have seen the incremented version of that counter (because the counter is monotonic and only counts up) and therefore will not know what the encrypted representation of the incremented version of the counter will look like. Hence, encrypting the counters and enforcing the requirement for counters to be monotonic can protect against an attack which modifies the counters by simultaneously incrementing and decrementing different counters.

In order to prevent an attacker from predicting what the encrypted version of an incremented counter will look like the encryption operation can have the diffusion property in which changing one bit of the plaintext changes on average half of the bits of the cipher text (and vice versa). Hence, the attacker does not see a logical pattern in the values of the encrypted counters. However, if the attacker observes one counter which has been incremented beyond another counter, and if the counters have the same translation between plaintext and ciphertext representations then the attacker may be able to use the future values observed for one counter to increment a different counter. This can be mitigated in any of several ways. Encrypting each counter using an index of the counter (such as a global address) can mean that the relationship between plaintext and ciphertext counters is different for each counter, and therefore observing one counter cannot provide information regarding different counters. Alternatively, counters can be initialised to random values such that it is unlikely for any one counter to overlap with another counter, and therefore observing the values of one counter may not provide any information about the encrypted values of a different counter.

An attacker may also attempt to modify a counter by swapping it with another counter in the same node. If the monotonic function has a particular form (including when it is a commutative function, but also if it is a function that is not commutative in general but still produces the same result when certain values are swapped) this could lead to the same function value being calculated from the modified values (and hence the modified node passing the verification check) with individual counters being incorrect. To perform this attack the attacker may not need to know what the values of the counters are. This attack can be mitigated in any of several ways. For example, a monotonic function can be selected which produces a different value when the counters are swapped. For example, a weighted sum can be used as the monotonic function which assigns a different weight to each counter such that swapping counters produces a different function value. Alternatively, the counters can be encrypted using as an input an index of the counter. Then, when the counters are decrypted after being swapped by an attacker, the decrypted counters are not properly decrypted (because they are in the wrong locations) and therefore the calculated function value will not be equal the stored function value stored in the parent node. Alternatively, an encryption algorithm can be used which encrypts the counters together, meaning that swapping bits in the ciphertext is not equivalent to swapping bits in the plaintext.

The counters of each node may be provided with sufficient bits to make a counter overflow extremely uncommon. For example, when used for protecting data integrity the counters of a given node may be incremented each time data to be protected is accessed. Even in the worst case where data is updated every cycle, a relatively small counter can provide enough values to make the risk of overflowing very low.

Hence, it will be seen that storing in a second node a function value which is a monotonic function of monotonic counters stored in a first node can enable the integrity of the monotonic counters to be verified.

FIG. 4A schematically illustrates a node 88 storing monotonic counters. In particular, the node is shown as a decrypted representation because in some examples the encryption operation could cause counters to become mixed. The node of counters can be referred to as a block of counters. The counters may be further subdivided, into sub-blocks 92 of counters. The size of a sub-block 92 may be the size of an individual counter or could be the size of several counters. The size of a sub-block 92 may be a multiple of the number of bits used to represent a single counter such that counters do not overlap separate sub-blocks. The sub-block 92 may be the granularity at which counters are encrypted, and therefore may be chosen to equal the size of a chosen block cipher, such as 128 bits when the AES block cipher is used.

FIG. 4B is a schematic illustration of a node storing counters as split counters. It will be seen that the node comprises a single major counter 94 and several minor counters 96. A given counter value is calculated by combining the major counter with a minor counter, such as by concatenating the major and minor counters. In the example provided, the major counter occupies the most significant bits of the overall counter and each minor counter provides the least significant bits, e.g., the values 000001, 000010, and 000011 may be represented by storing the major counter 0000 and the minor counters 01, 10, and 11. This can reduce the average number of bits required to represent a counter, which can significantly reduce the storage requirements of a node or increase the number of counters stored in a given node. The possibility to use split counters is a significant advantage to using counters to protect integrity compared with techniques not using counters. When a minor counter reaches a maximum value and is further incremented, it is reset to a minimum value (e.g., 11 is reset to 00) and the corresponding major counter is incremented (0000 to 0001). The remaining minor counters may also be reset at this point. Certain sub-blocks of the node may only store minor counters, as shown in FIG. 4B. If a minor counter is reset, it may take a value it has previously taken, which means that representing counters as a combination of major and minor counters may remove the monotonicity of a given sub-block of counters. Therefore, an attacker may be able to increment the minor counter using a previously observed encrypted representation of the minor counter (an attacker may know that “01” in plaintext corresponds to e.g., “10” in ciphertext based on previous observations, allowing them to increment the minor counter from 00). However, this problem can be addressed by ensuring that each minor counter is encrypted in a way that takes as an input the major value. This will mean that the relationship between plaintext and ciphertext minor counters changes each time the major counter is incremented. Hence, previous observations of the relationship between a plaintext and ciphertext minor counter may not be useable for incrementing a minor counter that has been reset.

FIG. 4B shows encryption operations 94 for forming an encrypted representation of a block of split counters. It will be seen that the encryption operation is performed on separate sub-blocks of counters, and that each sub-block is encrypted taking as an input the value of the major counter. Hence, the technique shown in FIG. 4B allows split counters to be used whilst making it harder for an attacker to modify the monotonic counters.

FIG. 5 is a flow diagram illustrating a method of using an integrity tree to verify the integrity of counters stored in a first node.

At step 500, the integrity checking circuitry 36 retrieves root verification data 38 from the on-chip memory 34.

At step 502, the integrity checking circuitry 36 uses the root verification data to verify the second node. This process is discussed in further detail with reference to FIG. 6, below. Following step 502 the integrity of the function value stored in the second node has been verified.

At step 504, the integrity checking circuitry 36, via the memory controller 12, retrieves the function value from the second node (or has already retrieved the function value in the integrity checking step 502). When this second node is within the integrity tree 26 (when it is not stored in on-chip memory) the second node is decrypted using decryption circuitry 32 to retrieve the function value. The function value is the value within the second node which corresponds to the first node and can be determined based on the address of the first node. The function value may alternatively be retrieved from the cache 42 if it has previously been accessed. Doing so may speed up accessing the second node, and in certain cases may also allow step 502 to be skipped if the second node has previously been verified because the cache is on-chip and therefore it can be trusted that the cached node has not been modified. In any case, following step 504 the integrity checking circuitry has access to a previously stored function value which corresponds to the monotonic function of the two or more monotonic counters as they were stored to the first node.

At step 506, the integrity checking circuitry 36 retrieves and decrypts the two or more monotonic counters stored in the first node.

At step 508, the integrity checking circuitry 36 recalculates a function value by performing the monotonic function on the monotonic counters retrieved from the first node (the counters to be verified). For example, the integrity checking circuitry 36 could add the retrieved counter values together (if the monotonic function is addition) to generate a function value.

At step 510, the integrity checking circuitry compares the recalculated function value calculated in step 508 with the retrieved function value retrieved from the second node in step 504. If the values are equal, then it can be verified that the counters have not been modified whilst stored in the off-chip memory, and therefore the retrieved counter values can be used at step 514 (by the processor 6 or by the memory security unit 20 for data integrity checks, for example). If there is a mismatch between the two function values, then at step 512 the integrity of the retrieved counters cannot be verified.

It will be appreciated that the order of steps may not need to be the same as shown in FIG. 5. For example, the second node could be verified after it has been used to verify the first node, meaning that step 502 could take place later in the process. Some steps may also be performed in parallel to improve performance.

FIG. 6 is a flow diagram showing an example of the verifying step 502. In some examples, step 502 may be skipped if the second node is stored in trusted memory such as on-chip memory or has been cached since being previously verified. In some other examples, the second node may be verified using a message authentication code (or other equivalent value) stored in trusted memory or a message authentication code stored in an integrity tree. However, in other examples the second node is verified by stepping through the integrity tree as shown in FIG. 6.

At step 600 a parent node is retrieved and decrypted. This parent node is trusted and may be the root node. For example, the parent node may be stored in trusted memory. Alternatively, the parent node may be stored in non-trusted memory and protected by a MAC or hash of the parent node stored in trusted memory, or another known technique. The function value stored in the parent node on the path to the second node is selected.

At step 602, the two or more monotonic counters of the child node of the parent node are retrieved from non-trusted memory and decrypted.

At step 604, the two or more monotonic counters of the child node are used as inputs in the monotonic function to generate a function value. The calculated function value is compared with the function value selected in step 600 at step 606.

If the calculated and retrieved function values differ, then at step 608 it is determined that the second node cannot be verified.

If the function values do not differ, then at step 610 it is determined that the child node can be verified. At step 610 it is determined whether the child node is the second node. For example, as shown in FIG. 3 if there are 3 levels to the integrity tree, then leaf node 84 may be the first node and branch node 88 may be the second node. If the verification process starts by selecting node 88-R as the first parent node (as it can be verified using the trusted root value) then branch node 88 is selected as the first child node. Hence, with the tree shown in FIG. 3 at step 610 it is determined that the child node is the second node. However, in trees having more than three levels there may be further nodes between the second node (whichever second node this is—it is noted that the second node does not need to be a parent node of a leaf node but may be higher in the tree depending on which node is selected to be the first node) and the parent node selected at step 600. If at step 610 it is determined that the child node is not the second node, then at step 612 the child node becomes the new parent node. The child node has been verified at step 606 and therefore it can be trusted and used to verify a further node. The monotonic counter in the previous child node, which is the new parent node, on the path to the second node is selected as the function value, and the node which is the child node of the new parent node on the path to the second node is selected as the new child node. The process then returns to step 602 with the new parent and child nodes in order to verify the integrity of the new child node. This process repeats until at step 610 it is determined that the verified child node is the second node, at which point it is determined at step 614 that the second node can be verified.

FIG. 7 is a flow diagram showing an example use of verified counters for verifying the integrity of an item of data stored in a non-trusted memory.

At step 700 it is determined which counter in a counter integrity tree corresponds to an item of data stored in the non-trusted memory. The determination could be made based on an address of the item of data or using another method, such as a stored pointer to indicate which counter corresponds to the item of data. The counter corresponding to the item of data is verified using the integrity tree.

At step 702 the item of data is retrieved from the non-trusted memory and optionally decrypted. A message authentication code corresponding to the item of data is also retrieved from the memory. In some examples the item of data and the MAC are stored together in a region of memory, but this is not necessary, and they can be stored separately.

At step 704, the MAC is recalculated based on the retrieved item of data and the verified counter retrieved at step 700. The use of the counter prevents an attacker from replacing the data and corresponding MAC with a previously valid pair of data and MAC which would then pass the integrity check if not for the use of a further value. If the data (or indeed the stored MAC) has been modified, then the MAC calculated at step 704 will not be the same as the stored MAC retrieved at step 702. This comparison is made at step 706. If there is a mismatch, then at step 708 it is determined that the integrity of the item of data cannot be verified. If the calculated and retrieved MACs match, then at step 710 it is determined that the integrity of the item of data can be verified.

It will be appreciated that the steps may not necessarily take place in the order shown. For example, in some cases the counter may not be verified prior to steps 702-710. Instead, these steps may take place with the presumption that the counter is valid. Step 700 may need to take place before allowing the “verified” data to be used, and in this case the outcome of step 700 would either confirm that the counter was indeed valid, allowing the data to be used if the MACs matched at step 706, or determine that the counter was not in fact valid, and therefore that the integrity of the data could not be verified despite the matching MACs. In addition, two or more of the steps shown in FIG. 7 may take place in parallel.

FIG. 8 is a flow diagram showing how a monotonic counter in the integrity tree can be incremented. If the monotonic counter is used for data integrity checking, it may be incremented each time the item of data to be protected is updated. If the counter is used to generate IDs, it may be updated each time a new ID is generated, for example.

At step 800, the integrity of the first node of the counter integrity tree is verified. This involves verifying the integrity of each node on the path from the root node to the first node. For example, the process shown in FIGS. 5 and 6 may be followed. In certain update operations the integrity checking may be performed to prevent the update operation from hiding errors in the tree.

At step 801, the monotonic counter in the first node is incremented. For example, the first node may be retrieved from memory, decrypted, and verified using the second node. The relevant counter of the first node is selected and incremented.

At step 802, the integrity checking circuitry uses the updated counter values of the first node as inputs in the monotonic function to generate a new function value.

At step 804, the updated function value is used to update the relevant function value stored in the second node (the second node may be retrieved and decrypted as part of this process, unless it has already been cached when used to verify the first node). The relevant function value is the function value on the path to the first node.

At this point the function value in the second node now corresponds to the updated counters of the first node and the first node can therefore be verified using the second node. However, because the second node has been updated then it may be necessary to perform updates further up the tree to allow the second node to be verified by its parent node, and so on.

Therefore, at step 806 it is determined whether the second node is the root node at the top of the integrity tree. If not, the, the second node can be considered to be the new first node (because it is a node for which a function value, which is a counter, has been incremented in a similar way to step 800) and the parent node of the previous second node can be considered the new second node. The process can then return to 802 and so on to make changes up the integrity tree to allow the updated first node to be verified.

At step 810 it is determined that the newly updated second node is the root node, and therefore the entire path of the tree leading to the incremented counter has been updated.

It will be appreciated that FIG. 8 shows only one example of a technique for updating the integrity tree, and that alternative examples exist. For example, if the monotonic function used at step 802 were a sum, then incrementing the monotonic counter of the first node and calculating the monotonic function for each parent node would be technically equivalent to incrementing the counter at each node by the same amount. In one technique for updating the counter integrity tree, rather than verifying each node on the path from the root node to the first node (at step 800), when the monotonic function is a sum the increment to be added to the first node could simply be added to (the decrypted representations of) each counter stored on the path from the first node to the root node. In this way, if the tree has been previously corrupted then the updated tree would stay corrupted, and an integrity check would be able to identify that the tree has been modified incorrectly. This means that an integrity check is not needed when updating the tree (as the later integrity check performed when using the tree will be sufficient to identify the error). This technique enables integrity verification to be skipped during an update because it does not recalculate the monotonic function for each node based on an updated child node. By omitting the verification step, this process may be performed quicker than that shown in FIG. 8, although it may be limited to particular forms of the monotonic function such as addition, in which an increment at the first node leads to predetermined changes to each parent node.

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software-based implementation of a hardware architecture. Varieties of simulator computer programs include emulators, virtual machines, models, and binary translators, including dynamic binary translators. Typically, a simulator implementation may run on a host processor hardware 900, optionally running a host operating system 905, supporting the simulator program 910. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware 900, or provide an instruction execution environment typically associated with a different hardware architecture. An overview of simulation is given in “Some Efficient Architecture Simulation Techniques,” Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 900), some simulated embodiments may make use of the host hardware, where suitable.

The simulator program 910 may be stored on a computer-readable storage medium (which may be a non-transitory medium) and provides a program interface (instruction execution environment) to the target code 915 (which may include applications, operating systems and a hypervisor) which is the same as the interface of the hardware architecture being modelled by the simulator program 910. Thus, the program instructions of the target code 915 may be executed from within the instruction execution environment using the simulator program 910, so that a host computer 900 which does not actually have the hardware features of the apparatus discussed above can emulate these features. The simulator program 910 may have counter integrity tree program logic 920 which emulates the functionality of the counter integrity tree circuitry (which may be embodied by the memory security unit 20), and integrity checking program logic 925 which emulates the functionality of the integrity checking circuitry 36, as described above.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
counter integrity tree circuitry configured to maintain a counter integrity tree comprising a plurality of nodes;
wherein the counter integrity tree circuitry is configured to store:
in a first node of the counter integrity tree, an encrypted representation of two or more non-repeating counters; and
in a second node of the counter integrity tree, which is a parent node of the first node, an indication of a function value equal to a non-repeating function of the two or more non-repeating counters of the first node; and
integrity checking circuitry configured to check the integrity of the first node using the function value retrieved from the second node.

2. The apparatus according to claim 1, wherein
the two or more non-repeating counters are two or more monotonic counters; and
the non-repeating function of the two or more non-repeating counters of the first node is a monotonic function of the two or more monotonic counters of the first node.

3. The apparatus according to claim 1, wherein
the first node and the second node are stored in non-trusted memory;
the counter integrity tree circuitry is configured to store an encrypted representation of the function value in the second node; and
the integrity checking circuitry is configured to check the integrity of the second node using a further node of the counter integrity tree.

4. The apparatus according to claim 1, wherein the first node is stored in non-trusted memory and the second node is stored in trusted memory.

5. The apparatus according to claim 1, wherein
the integrity checking circuitry is configured to check the integrity of the first node by:
generating a decrypted representation of the two or more non-repeating counters by decrypting the encrypted representation of two or more non-repeating counters retrieved from the first node;
calculating the non-repeating function of the two or more non-repeating counters of the decrypted representation; and
comparing the calculated non-repeating function with the function value retrieved from the second node.

6. The apparatus according to claim 1, wherein
the function value, which is the non-repeating function of the two or more non-repeating counters of the first node, is a non-repeating counter.

7. The apparatus according to claim 1, wherein
the monotonic function of the two or more monotonic counters is a weighted sum of the two or more monotonic counters.

8. The apparatus according to claim 1, wherein the encrypted representation of the two or more non-repeating counters is calculated in one of:
a single encryption operation to encrypt all of the two or more non-repeating counters as a block, which takes as an input an index of the first node; and
two or more encryption operations each encrypting a sub-block of non-repeating counters, wherein the encryption operation for creating an encrypted representation of a given sub-block of non-repeating counters takes as an input an index of the given sub-block.

9. The apparatus according to claim 1, wherein
the counter integrity tree circuitry is configured to initialise the counter integrity tree by setting the two or more non-repeating counters to initial counter values, wherein the initial counter values are randomly selected.

10. The apparatus according to claim 1, wherein
the two or more non-repeating counters of the first node are used to check the integrity of data stored in the non-trusted memory.

11. The apparatus according to claim 10, wherein
the integrity checking circuitry is configured to check the integrity of an item of data retrieved from the non-trusted memory based on a comparison between a stored authentication code and a generated authentication code generated based on the item of data and a corresponding decrypted non-repeating counter of the two or more non-repeating counters retrieved from the first node.

12. The apparatus according to claim 1, wherein
the first node does not contain a message authentication code.

13. The apparatus according to claim 1, wherein
the encrypted representation of the two or more non-repeating counters is calculated in one or more encryption operations each encrypting a sub-block of non-repeating counters,
wherein the counter integrity tree circuitry uses an encryption algorithm which when applied to a given sub-block, encrypts the given sub-block such that when one bit of the encrypted representation of the given sub-block is changed, more than one bit of the decrypted representation of the given sub-block changes.

14. The apparatus according to claim 1, wherein
the counter integrity tree circuitry is configured to decrypt the encrypted representation of the two or more non-repeating counters without using a value derived from another node in the counter integrity tree.

15. The apparatus according to claim 1, wherein
the counter integrity tree circuitry is configured to store in the first node of the counter integrity tree:
a major counter shared between the two or more non-repeating counters; and
two or more minor counters, wherein a given minor counter corresponds to a given non-repeating counter, and the given non-repeating counter is equal to a combination of the major counter and the given minor counter; and
the counter integrity tree circuitry applies an encryption algorithm which ensures that the encryption of each minor counter takes as an input the value of the major counter.

16. The apparatus according to claim 15, wherein
the encrypted representation of the two or more non-repeating counters is calculated in two or more encryption operations each encrypting a sub-block of non-repeating counters, wherein the encryption operation for creating an encrypted representation of a given sub-block which contains only minor counters takes as an input the value of the major counter.

17. The apparatus according to claim 1, wherein
the counter integrity tree circuitry is configured to store, in the first node, a representation of metadata; and
the function value is equal to the non-repeating function of the two or more non-repeating counters and the metadata.

18. The apparatus according to claim 1, wherein
each node of the counter integrity tree other than a protected root node is stored in the non-trusted memory, and stores an encrypted representation of two or more non-repeating counters;
a parent node of each node other than the protected root node stores, for each child node, an indication of a function value equal to the non-repeating function of the two or more non-repeating counters of that child node; and
the integrity checking circuitry is configured to check the integrity of a given node using the function value retrieved from the parent node of the given node.

19. A method of operating a data processing apparatus to maintain integrity of non-repeating counters, comprising:
maintaining a counter integrity tree comprising a plurality of nodes;
storing, in a first node of the counter integrity tree, an encrypted representation of two or more non-repeating counters;
storing, in a second node of the counter integrity tree, which is a parent node of the first node, an indication of a function value equal to a non-repeating function of the two or more non-repeating counters of the first node; and
checking the integrity of the first node using the function value retrieved from the second node.

20. A computer program for controlling a host data processing apparatus to provide an instruction execution environment, comprising:
counter integrity tree program logic to maintain a counter integrity tree comprising a plurality of nodes;
wherein the counter integrity tree program logic is arranged to store:
in a first node of the counter integrity tree, an encrypted representation of two or more non-repeating counters; and
in a second node of the counter integrity tree, which is a parent node of the first node, an indication of a function value equal to a non-repeating function of the two or more non-repeating counters of the first node; and
integrity checking program logic to check the integrity of the first node using the function value retrieved from the second node.
